(19) United States
(12) Patent Application Publication
(10) Pub. No.: US 2021/0059020 A1
(43) Pub. Date: Feb. 25, 2021

(54) HEATING DEVICE

(71) Applicant: Salvatore MORALE, LIVORNO (IT)

(72) Inventor: Salvatore MORALE, LIVORNO (IT)

(21) Appl. No.: 16/958,460

(22) PCT Filed: Dec. 27, 2018
(86) PCT No.: PCT/IB2018/060635

§ 371 Date: Jun. 26, 2020

(30) Foreign Application Priority Data
Jan. 4, 2018 (IT) 102018000000557

(51) Int. Cl. H05B 3/26

(52) U.S. Cl. CPC H05B 3/26

(57) ABSTRACT

A heating device configured to heat an object including an emitter of thermal radiation; and a radiating plate defining a propagation surface to face the object, and an absorption surface for adsorbing the thermal radiation coming out of the emitter; the radiating plate is not in contact with the emitter, so as to be heated by irradiation, and not in contact with the object, so as to heat it by irradiation.

The present invention relates to a heating device of the type specified in the preamble of the first claim.

In particular, the device is suitable to be used for heating objects, people, rooms/buildings. For example, it is identifiable as a drier and therefore as a heating device that can be used to heat and then dry paint products applied to mechanical vehicles, means of transport for the transfer of people, animals or things such as, for example, cars, motorbikes, trucks, buses, train carriages, trams and planes.

To date, spray booth-ovens are used as the heating devices for drying paint products, the vehicle with the paint product applied thereto being arranged therein.

The use of hot air is provided in the spray booth and the heat required for surface treatment is transmitted by convection. The hot air is fed from a plenum located on the ceiling of the booth-oven and extracted through a floor grid of the booth-oven. Other heating devices are, for example, the radiator identifiable as a component of the heating system for heating rooms for civilian use.

The radiator is composed of elements, i.e. modules in series inside which a hot fluid is circulated, which are placed side by side to attain the desired heating surface.

These modules are hollow and adjacent to the wall so as to create convective air motions by which the environment/room is heated.

In some cases, the known radiators are equipped with a forced ventilation system applicable thereto and suitable to accelerate the circulation of hot air in the room generated by this heating device.

The prior art has a few major drawbacks.

In fact, the hot air, by hitting the vehicle being dried, entails that the part underneath the outer surface will dry in a much longer time (about 40 days) so much so that it is defined as the “maturation time” of the drying of the paint products, which can lead to the surfacing of bubbles on the vehicle bodywork after several days from intervention on the bodywork.

Another drawback is the energy consumption of the known heating devices, especially if intended for the drying of paint products. In fact, even if subjected to small and localised repairs, vehicles require the introduction of hot air throughout the booth-oven as if they were to be dried completely, thus making the process very costly in terms of economy, energy and time.

In detail, this aspect appears to be boosted by the fact that the known heating devices, by heating the air, need to heat the entire booth to allow the paint product to reach the desired drying temperature.

Another drawback is the slowness of the drying, and in particular the slowness in bringing the booth up to temperature.

In the prior art, the problem with the use of the known radiating devices in booth-ovens for the drying of paints is the huge energy consumption increased by the poor performance of the known devices.

It should be noted that the aforementioned drawbacks can also be found in other applications of known heating devices.

For example, in the use of heating devices for rooms/buildings, we can be readily aware of the long time required to heat the room evenly and of the high temperature of the heating devices compared to that of the room.

In this context, the technical task underlying the present invention is to devise a heating device, which is capable of substantially obviating at least some of the above-mentioned drawbacks.

Within the scope of said technical task, a major object of the invention is to obtain a heating device which allows the desired temperature to be reached in a quick and inexpensive way.

It is therefore an object of the present invention to obtain a heating device which allows a paint product to be dried optimally and/or a room to be heated in a fast, quick and inexpensive way.

The technical task and the specified objects are achieved by means of a heating device as claimed in appended claim 1. Preferred embodiments are described in the dependent claims.

The features and advantages of the invention will be clarified in the following detailed description of preferred embodiments of the invention, with reference to the accompanying drawings, in which:

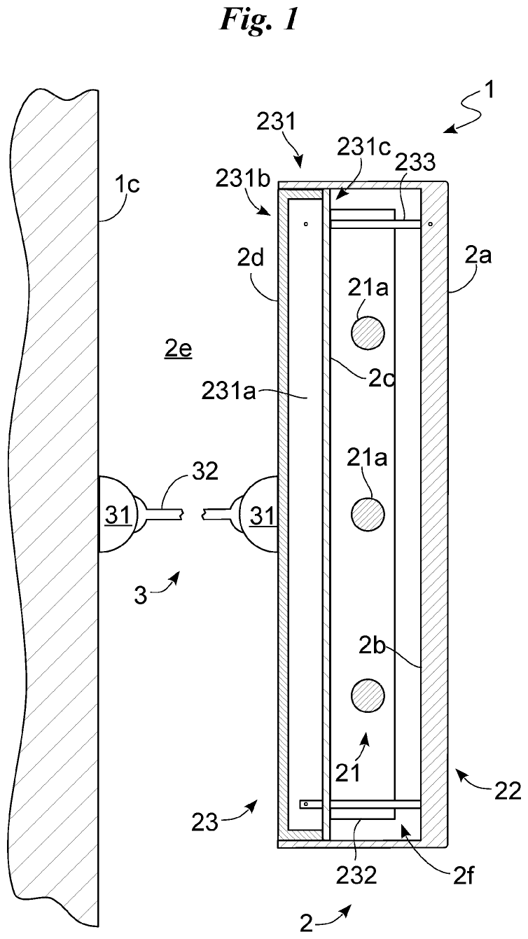

FIG. 1 shows a heating device according to the invention;

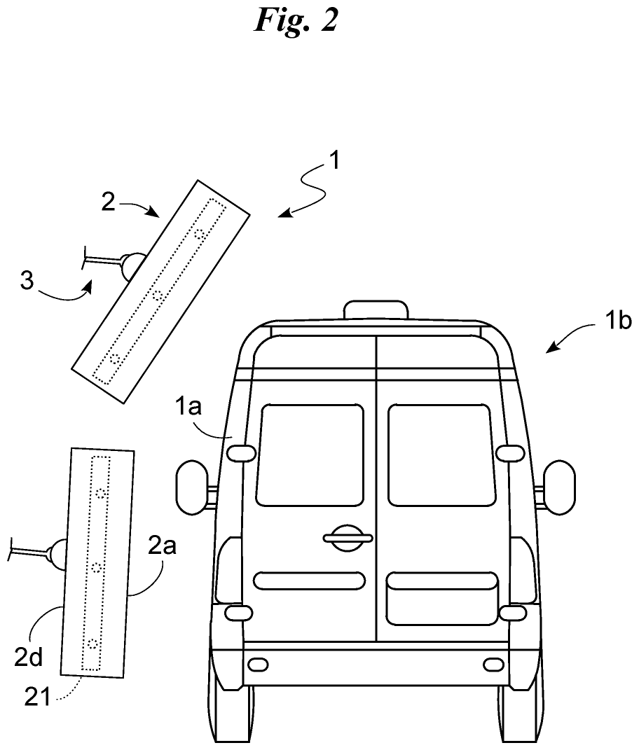

FIG. 2 shows a possible application of the heating device; and

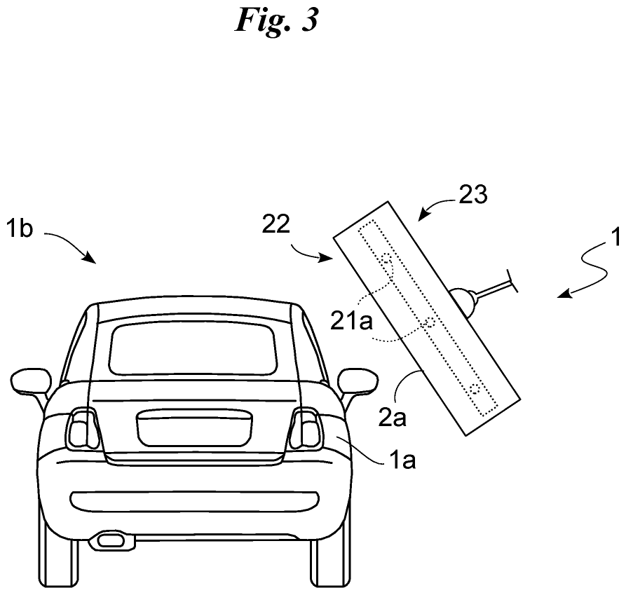

FIG. 3 shows another application of the heating device.

Herein, the measures, values, shapes and geometric references (such as perpendicularity and parallelism), when used with words like “about” or other similar terms such as “approximately” or “substantially”, are to be understood as except for measurement errors or inaccuracies due to production and/or manufacturing errors and, above all, except for a slight divergence from the value, measure, shape or geometric reference with which it is associated. For example, these terms, if associated with a value, preferably indicate a divergence of not more than 10% from said value.

Furthermore, when used, terms such as “first”, “second”, “higher”, “lower”, “main” and “secondary” do not necessarily identify an order, a priority relationship or a relative position, but can simply be used to distinguish more clearly the different components from each other.

The measurements and data reported in this text are to be understood as carried out in the International Standard Atmosphere ICAO (ISO 2534), unless otherwise indicated.

With reference to the Figures, the heating device according to the invention is indicated as a whole by the numeral 1.

The heating device is suitable to heat at least one object 1a to be heated.

It is suitable to be used for heating objects, people, rooms/buildings. For example, it is identifiable as a heating device for a room, a building, or other similar environment.

In another example, the heating device 1 is identifiable as a drier for paint products (FIGS. 2 and 3) and therefore it is suitable to be placed inside a booth for the drying of paint products (coinciding with the object 1a to be heated and then dried), for example applied to a vehicle 1b. Said booth may thus comprise one or more heating devices 1.

The heating device 1 is advantageously suitable to heat the object 1a (dry paint products and/or heat a room) through emission of thermal radiation (identifiable as electromagnetic waves) and thus by irradiation. In particular, it is suitable to dry the object 1a mainly by irradiation, which can be combined with heat transfer by conduction and/or convection.

In this document, the term “insulating”, even if not specified, is always to be understood as referring to thermal insulation.

The heating device 1 comprises at least one panel 2 defining a propagation surface 2a suitable to face the object 1a.

In the case of a heating device 1 for paint products, the propagation surface 2a is suitable to face the paint product (FIGS. 2 and 3) to be dried. Alternatively, in the case of a heating device 1 for rooms, the propagation surface 2a is suitable to face the room to be heated.

The propagation surface 2a may be flat or curved. For example, in the case of a heating device 1 for paint products, it may be convex or concave according to the profile on which the paint product is applied.

Preferably, the propagation surface 2a is suitable not to be in contact with the object 1a when in use. In detail, the distance between the propagation surface 2a and the object 1a can be substantially at least 0.1 m and in detail substantially between 0.1 m and 1 m, and more precisely between 0.35 m and 0.50 m.

The panel 2 is suitable to heat the object 1a through emission of thermal radiation coming out of the propagation surface 2a and incident to the object to be heated. In particular, it is suitable to heat the object 1a mainly by irradiation, which can be combined with heat transfer by conduction.

The panel 2 comprises an emitter 21 of said thermal radiation.

Preferably, the emitter 21 may comprise at least one electrical resistance 21a and in detail a plurality of distinct electrical resistances 21a substantially parallel to each other.

The at least one resistance 21a is parallel to the propagation surface 2a.

The at least one resistance 21a is a mineral insulated cable.

Optionally, the emitter 21 defines the propagation surface 2a.

Alternatively, the panel 2 may comprise a radiating plate 22 defining the propagation surface 2a and an absorption surface 2b for adsorbing the thermal radiation coming out of the emitter 21.

The radiating plate 22 is suitable to be, in use, between the emitter 21 and the object 1a.

The surfaces 2a and 2b are on opposite sides of the radiating plate 22.

The absorption surface 2b may be substantially parallel to the propagation surface 2a.

The propagation surface 2a is suitable to be, in use, not in contact with the object 1a. Therefore, in use, the radiating plate 22 is not in contact with the object 1a, hence spaced apart from it, so that heat is transferred from the plate 22, and in particular from the propagation surface 2a, to the object 1a by irradiation. More precisely, said heat transfer can mainly occur by irradiation, which can be combined with heat transfer by conduction.

The propagation surface 2a may be a surface with high thermal radiation emissivity. It has an emissivity of at least 0.5, in detail 0.7, more in detail 0.8, and preferably 0.9.

Alternatively, the propagation surface 2a may be smooth.

The propagation surface 2a may be light-coloured, and in particular white. In some cases, the propagation surface 2a can have a different colour, and in detail opposite to that of the object 1a, so as to at least emit thermal radiation with a frequency and/or wavelength equal or similar to that absorbed by the object 1a. These solutions are preferred for devices 1 for paint products.

La propagation surface 2a is matt.

Alternatively, the propagation surface 2a can be dark in colour (in particular black) and for example physically similar to that of a black body. This solution is preferred in cases of heating devices 1 used to heat rooms.

The absorption surface 2b can be in contact or not with the emitter 21.

Preferably, it is not in contact with the emitter 21. Therefore, the radiating plate 22 is not in contact with the emitter 21, hence spaced apart from it, so that heat is transferred from the emitter 21 to the plate 22, and in particular to the absorption surface 2b, by irradiation. More precisely, said heat transfer can mainly occur by irradiation, which can also be combined with heat transfer by conduction.

It should be noted that, in the alternative case of the absorption surface 2b in contact with the emitter 21, heat transfer can suitably occur primarily by irradiation and secondarily by conduction.

The absorption surface 2b may be a surface with high thermal radiation absorbability. It has an absorption coefficient of at least 0.5, in detail 0.7, more in detail 0.8, and preferably 0.9. The absorption surface 2b can be dark in colour (in particular black) and/or rough and therefore have indentations/crinkles increasing the absorption. The absorption surface 2b can be dark in colour (in particular black) and for example physically similar to that of a black body. Advantageously, it is black.

The absorption surface 2b can be selectively matt or bright.

In some cases, the absorption surface 2b may have a colour analogous and/or similar to that of the object 1a to be dried (i.e., being dried), so as to at least absorb thermal radiation with a frequency and/or wavelength equal or similar to that absorbed by the object 1a.

In the preferred example, the absorption surface 2b can be dark in colour (in particular black) (selectively matt or bright) and the propagation surface 2a is white and suitably matt.

It should be noted that when the absorption surface 2b and the propagation surface 2a are dark in colour (in particular black), the radiating plate 22 is substantially identifiable as a black body.

Optionally, the radiating plate 22 can comprise a contouring subtended between the surfaces 2a and 2b, suitably allowing thermal expansion of the radiating plate 22 in height and\or in width.

Said contouring is thermally insulating so as to prevent loss of heat, which can therefore exclusively escape from the propagation surface 2a.

The panel 2 may comprise a support 23 for the emitter 21 and, if present, for the radiating plate 22.

In particular, the housing 2f is closed.

Conveniently, the housing 2f is thermally insulated from the outside, with the sole exclusion of the propagation surface 2a. To this end, at least the side walls, i.e. perpendicular to the propagation 2a, support 23 and radiating plate 22 surfaces, can be thermally insulating (preferably with low heat and\or thermal radiation absorption).

Optionally, the side walls may have internal surfaces, i.e. facing the housing 2f, reflective and optionally with a reflection coefficient of at least 0.5, in detail 0.7, more in detail 0.8, and preferably 0.9.

The support 23 is suitable to be, in use, on the opposite side of the object 1a, and more precisely of the radiating plate 22 with respect to the emitter 21.

The support 23 may comprise a base body 231 suitably placed on the opposite side of the absorption surface 2b with respect to the emitter 21.

The support 23 (in particular the base body 231) and the radiating plate 22 define, suitably for the panel 2, a box-like body delimiting a housing 2f for the emitter 21.

The base body 231 defines a reflective surface 2c facing said emitter 21 and hence the possible absorption surface 2b.

The reflective surface 2c is on the opposite side of the absorption surface 2b with respect to the emitter 21.

The reflective surface 2c is suitable to reflect the thermal radiation coming out of the emitter 21 on the opposite side of the object 1a, thus toward the same object 1a.

Preferably, it is suitable to reflect the thermal radiation coming out of the emitter 21 on the opposite side of the radiating plate 22 toward the absorption surface 2b. The absorption surface 2b thus absorbs the thermal radiation reflected by the reflective surface 2c.

As a result, when the emitter 21 emits thermal radiation, the radiating plate 22 is directly and indirectly heated by the emitter 21. In detail, the radiating plate 22 is heated directly by the thermal radiation emitted by the emitter 21 in the direction of\toward the absorption surface 2b of said plate 22; and indirectly by the thermal radiation emitted by the emitter 21 in the direction of\toward the reflective surface 2c (in detail opposite the radiating plate 22), which is reflected by said reflective surface 2c in the direction of the absorption surface 2b of the radiating plate 22.

The reflective surface 2c can have a reflection coefficient of at least 0.5, in detail 0.7, more in detail 0.8, and preferably 0.9. It can be mirroring and preferably smooth and/or coated, at least partly and preferably totally, with microspheres of glass or other similar elements suitable to improve the reflexivity thereof.

The reflective surface 2c may be flat, and in particular parallel to the propagation surface 2a. Alternatively, it is convex so as to maximize the conveyance of the radiation toward the object 1a, and in detail toward the absorption surface 2b.

The base body 231 is preferably thermally insulating so as to prevent heat loss in the direction of the external structure 1c, thus on the opposite side of the object 1a.

The base body 231 may define, on the opposite side of the reflective surface 2c, a thermally insulating surface 2d suitable not to disperse any heat (at least the thermal radiation) absorbed by the body 231.

The surfaces 2c and 2d are on opposite sides of the base body 231.

The insulating surface 2d may be a surface with low thermal radiation emissivity. It has an emissivity of at least less than 0.5, in detail less than 0.3, more in detail less than 0.2, and preferably less than 0.1.

The insulating surface 2d may be flat, and in particular parallel to the propagation surface 2a.

Optionally, the base body 231 may comprise an edge subtended between the surfaces 2c and 2d and thermally insulating.

Preferably, the base body 231 defines therein a suitably sealed inner chamber 231a interposed between the insulating surface 2d and the reflective surface 2c.

The inner chamber 231a is preferably filled with a thermally insulating material such as an insulating gas. Alternatively, the chamber 231a is filled with air.

In particular, the base body 231 is identifiable as a box-like body defining said inner chamber 231a. It comprises a rear wall 231b defining the insulating surface 2d and a front wall 231c defining the reflective surface 2c.

The insulating surface 2d of the rear wall 231b externally faces the heating device 1, i.e. the anchorage system 3, and therefore the external structure 1c.

The rear wall 231b defines at least one surface facing the inner thermally insulating chamber so as to limit heat absorption by said rear wall 231b.

The reflective surface 2c of the front wall 231c faces the emitter 21.

The front wall 231c defines at least one surface facing the inner thermally insulating chamber so as to limit heat absorption by said front wall 231c.

The base body 231 is suitable to support the emitter 2. To this end, the support 23 may comprise a grid 232, or other element with the same function, constraining the emitter 21 to the base body 231.

As an alternative to the grid 232, the panel 2 may comprise one or more mutually distinct supports 23 supporting the element 21.

The support 23 may comprise constraint means 233 for constraining the radiating plate 22 to the base body 231.

The heating device 1 may comprise at least one anchorage system 3 for anchoring the panel 2 to a wall or other external structure 1c.

The anchorage system 3 is suitable to constrain the panel 2 to an external structure, thereby turning the insulating surface 2d towards said external structure. In particular, it is suitable to constrain the panel 2 to an external structure 1c, spacing the insulating surface 2d from the external structure so that a channel 2e is defined therebetween.

Since the insulating surface 2d, and in particular the entire base body 231 is almost incapable of absorbing heat and transferring it to the channel 2e, the latter does not heat up, thus avoiding heat loss from the device 1.

The anchorage system is suitable to vary the inclination of the propagation surface 2a with respect to the gravitational gradient. It may thus comprise at least one hinge 31 defining an axis of rotation of the panel 2 with respect to the external structure 1c.

The anchorage system is suitable to vary the distance of the insulating surface 2d from the external structure 1c. It may thus comprise at least one handler 32, for example a telescopic handler, suitable for moving the panel 2 with respect to the external structure 1c.

The operation of the heating device 1, described above in structural terms, introduces a new method of heating an object 1a.

The method provides that the object 1a is heated by irradiation, for example that a paint product is dried by irradiation. In particular, the drying method is suitable to heat an object 1a (for example to dry paint products) mainly by irradiation, which can be combined with heat transfer by conduction and/or convection.

In particular, the heating method provides that the emitter 21 heats the radiating plate 22 at least (suitably exclusively) by irradiation of thermal radiation emitted by said emitter 21 and that the radiating plate 22 heats the object 1a by irradiation.

More in particular, the heating method provides that the emitter 21 heats the radiating plate 22 mainly by irradiation and that the radiating plate 22 heats the object 1a mainly by irradiation.

In detail, the drying method provides that the emitter 21 generates and emits thermal radiation in the direction of the object 1a. Such thermal radiation comes out of the emitter, and once the distance separating the emitter 21 from the radiating plate 22 has been travelled, it strikes the absorption surface 2b and can then be collected by the radiating plate 22. As a result, the radiating plate 22 heats up and starts emitting thermal radiation from the propagation surface 2a towards the object 1a, which in turn heats up.

At the same time, part of the thermal radiation coming out of the emitter 21 strikes the reflective surface 2c of the base body 231. Such thermal radiation is at least partially, and in detail almost totally reflected by the reflective surface 2c towards the absorption surface 2b, causing an increase in the thermal radiation coming out of the propagation surface 2a.

In summary, the radiating plate 22 is heated twice by the emitter 21, i.e. directly by the thermal radiation emitted by the emitter 21 towards the plate and indirectly by the thermal radiation emitted on the opposite side and then reflected.

It should be noted that if thermal radiation striking the reflective surface 2c is absorbed by the base body 231, thanks to its particular thermally insulating structure and therefore almost incapable of dispersing heat, it does not heat up, thus avoiding dispersion of heat towards the wall (or external structure 1c).

Strong heating of the radiating plate 22 is guaranteed by the housing 2f which, being thermally insulating, prevents heat loss and its concentration in said radiating plate 22 and then towards the object 1a.

The heating device 1 according to the invention achieves important advantages. In fact, unlike the currently used processes/devices, the heating device 1 and therefore the drying method described above mainly use irradiation, thereby improving and speeding up the entire operation of heating of the object 1a. This aspect is substantially defined by the double heating of the radiating plate 22 ensured by the particular device 1 and the method implemented by it. In fact, when the emitter 21 emits thermal radiation, the radiating plate 22 is heated directly by the thermal radiation emitted towards the absorption surface 2b by the emitter 21, and indirectly by the thermal radiation emitted by the emitter 21 towards the reflective surface 2c and reflected by the same in the direction of the absorption surface 2b. This advantage makes it possible, for example, to operate at much lower temperatures and to significantly reduce the power required of the device 1 and the time and cost for drying objects 1a. On the other hand, by using a device 1 with the same electrical power as the devices of the prior art, much higher temperatures are reached on the radiating plate 2 (which can thus have high temperatures up to 300-350° C. when drying paint products and even 85° C.-90° C. in the residential sector), thus allowing heating/drying time and costs to be further reduced compared to the prior art.

This is due to the fact that, while previously, in order for the object 1a to have a desired temperature, the heat source had to reach temperatures much higher than said desired temperature, it suffices that the heating device 1 reach temperatures equal to or at most only slightly higher than said predetermined temperature.

Furthermore, by using irradiation, the heating device 1 heats the object 1a without propagation means (air in the case of known devices), thus limiting the dispersion thereof.

Other important aspects are represented by the particular selection of the surfaces 2a, 2b and 2c.

In fact, since the propagation surface 2a is flat, it allows the thermal radiation output therefrom to be diffused evenly. Moreover, in the particular case of paint products, it favours the drying thereof.

The high emissivity of the propagation surface 2a maximizes the thermal radiation output therefrom.

An important advantage is represented by the particular base body 231 which, thanks to the particular walls 231b and 231c, does not absorb heat and reflects it towards the object to be heated, thus maximizing the effectiveness of the heating device 1.

Other advantages are given by the absorption surface 2b, which maximizes the thermal radiation absorbed by the radiating plate 22, and therefore the thermal radiation output from the propagation surface 2a.

It should be noted that this aspect is also boosted by the reflective surface 2c which, by reflecting and/or conveying the heat towards the absorption surface 2b, further increases the radiation emitted by the propagation surface 2a.

The above-described advantages have been obtained by providing a heating device 1 “totally by irradiation” i.e. using thermal energy transfer totally by irradiation by the emitter 21 towards the absorption surface 2b (suitably treated to have high absorbability) and towards the reflective surface 2c suitably with high reflecting power.

The heating device 1 is thus completely released from the limitation of the physical contact between the inside of the radiating plate and the electric heating element, which characterizes the known devices.

Ultimately, the release from the physical contact between the emitter 21 and the radiating plate 22 opens the door to the possibility of producing heating devices 1 from 90° C. to 350° C., unthinkable to be done with the prior art endothermic panels on the market today.

The invention is susceptible of variations falling within the scope of the inventive concept as defined by the claims. In this context, all details are replaceable by equivalent elements. Any materials, shapes and sizes can be used.

1. A heating device configured to heat an object, comprising:
an emitter of thermal radiation;
a radiating plate defining a propagation surface configured to face said object, and an absorption surface for adsorbing said thermal radiation coming out of said emitter opposite to said propagation surface with respect to said radiating plate; and
a base body
placed on the opposite side of said radiating plate with respect to said emitter,
thermally insulating and
defining a reflective surface for reflecting said thermal radiation, which faces said absorption surface and said emitter;
wherein said radiating plate is configured to be heated by said thermal radiation emitted by said emitter and reflected by said reflective surface and to heat said object by irradiation.

2. The heating device according to claim 1, wherein said propagation surface has an emissivity of at least 0.8.

3. The heating device according to claim 2, wherein said propagation surface is white.

4. The heating device according to claim 1, wherein said absorption surface has an absorption coefficient of at least 0.8.

5. The heating device according to claim 4, wherein said absorption surface is black.

6. The heating device according to claim 1, wherein said base body and said radiating plate define a box-like body delimiting a housing for said emitter.

7. The heating device according to claim 6, wherein said housing is closed and thermally insulated from the outside, with the sole exclusion of said propagation surface.

8. The heating device according to claim 1, wherein said reflective surface has a reflection coefficient of at least 0.8.

9. The heating device according to claim 1, wherein said base body defines a thermally insulating surface opposite to said reflective surface with respect to said base body.

10. The heating device according to claim 1, wherein said base body defines a thermally insulating inner chamber interposed between said insulating surface and said reflective surface.

11. The heating device according to claim 10, wherein said inner chamber is filled with a thermally insulating material.

12. A method of heating an object comprising:
heating the object with a heating device comprising:
a panel defining a propagation surface configured to face said object;
an emitter of thermal radiation and a radiating plate not in contact with said emitter and defining a propagation surface configured to face said object, and an absorption surface for adsorbing said thermal radiation coming out of said emitter opposite to said propagation surface with respect to said radiating plate;
a base body
placed on the opposite side of said radiating plate with respect to said emitter,
thermally insulating and
defining a reflective surface reflecting said thermal radiation, which faces said absorption surface and said emitter; and
wherein said emitter emits said thermal radiation, and said radiating plate is heated by said thermal radiation emitted by said emitter and reflected by said reflective surface and heats said object by irradiation.

13. The method according to claim 12, wherein said propagation surface has an emissivity of at least 0.8.

14. The method according to claim 13, wherein said propagation surface is white.

15. The method according to claim 12, wherein said absorption surface has an absorption coefficient of at least 0.8.

16. The method according to claim 15, wherein said absorption surface is black.

17. The method according to claim 12, wherein said base body and said radiating plate define a box-like body delimiting a housing for said emitter.

18. The heating device according to claim 17, wherein said housing is closed and thermally insulated from the outside, with the sole exclusion of said propagation surface.
